(19) United States
(12) Patent Application Publication
(10) Pub. No.: US 2017/0078353 A1
(43) Pub. Date: Mar. 16, 2017

(54) Method, Apparatus and Communication Device For Handling Broadcasted or Multicasted Content

(71) Applicant: Telefonaktiebolaget LM Ericsson (publ), Stockholm (SE)

(72) Inventors: Jie LING, Shanghai (CN); Ibtissam EL KHAYAT, Glons (BE); Thorsten LOHMAR, Aachen (DE); Michael John SLSSINGAR, Skärholmen (SE); Woods WANG, Shanghai (CN); Jinyang XIE, Shanghai (CN)

(73) Assignee: Telefonaktiebolaget LM Ericsson (publ), Stockholm (SE)

(21) Appl. No.: 15/309,252

(22) PCT Filed: May 8, 2014
(86) PCT No.: PCT/SE2014/050568

§ 371 Date: Nov. 7, 2016

(51) Int. Cl. H04L 29/06; H04L 29/08; H04W 8/24; H04W 4/06

(52) U.S. Cl. CPC H04L 65/602; H04W 4/06; H04L 67/16; H04L 67/06; H04W 8/24

(57) ABSTRACT

A method executed in a network node capable of broadcasting or multicasting user content delivery to communication devices comprise: preparing of different versions of user content to be broadcasted or multicasted to the communication devices; preparing, for each version,a respective instruction arranged to instruct each of the communication devices to, based on its device capabilities, automatically select at least one of the broadcasted or multicasted user content version/s when the respective communication device is capable of handling the respective version/s and/or to automatically discriminate at least one of the broadcasted or multicasted user content version/s when the respective communication device is not capable of handling the respective version/s; transmitting the instructions to the communication devices via broadcasting or multicasting, and transmitting the different versions of user content to the communication devices via broadcasting or multicasting. A method for receiving such provided content is also described, as well as an apparatus and communication device on which these methods can be executed.

### TECHNICAL FIELD

The present disclosure relates to a method and arrangement for handling broadcasted or multicasted content selectively.

### BACKGROUND

Multimedia Broadcast and Multicast Services (MBMS) is a broadcasting service offered over Universal Terrestrial Radio Access Networks (UTRAN), while enhanced MBMS (eMBMS) is used to denominate MBMS services in Evolved Packet Systems, including e.g. Evolved UTRAN (E-UTRAN) for Long Term Evolution (LTE).

MBMS/eMBMS is a multicasting and broadcasting service which provides for efficient distribution of user content to a large number of receiving communication devices in a resource efficient way. In one scenario, which can be referred to as Linear Video Delivery, user content, such as e.g. live sport games video content can be delivered via multicasting or broadcasting to a large number of communication devices, gathered e.g. in a sport stadium. At such an occasion, the MBMS/eMBMS system may be configured to use the MBMS User Datagram Protocol/Download File Delivery over Unicast Transport (UDP/FLUTE) Method, as a protocol for delivering Live TV content to communication devices. The Live TV content can be segmented e.g. as Apple's HTTP Live Streaming (HLS) or as Dynamic Adaptive Streaming over HTTP (DASH) segment foes. According to another scenario, which can instead be considered to relate to delivery of binary files, MBMS/eMBMS can make use of the MBMS UDP/FLUTE method to deliver updates on popular files, such as e.g. Android updates, YouTube clip pre-loads, or news events.

However, as use of services, such as the ones mentioned above, increases, the demand for always being updated on a latest version of a specific service will result in a large amount of user content being delivered in parallel, where, the larger the number of available versions is, the larger number of versions unsuitable for a respective communication device will also be received by the communication devices. Communication devices will need to be able to handle such an increasing number of distributed versions.

Handling a version at a communication device which version later turns out to be incompatible with the device may result in unnecessary tying up of resources and also in a waste of battery capacity of the communication device. Consequently, there is a demand for a more optimal way of handling such data.

### SUMMARY

It is an object of the present document to address, or at least alleviate, at least some of the problems described above.

According to a first aspect, a method to be executed in a network node capable of broadcasting or multicasting user content delivery to communication devices is suggested. The method comprise: preparing different versions of user content to be broadcasted or multicasted to the communication devices; preparing, for each version, a respective instruction arranged to instruct each of the communication devices to, based on its device capabilities, automatically select at least one of the broadcasted or multicasted user content version/s when the respective communication device is capable of handling the respective version/s and/or to automatically discriminate at least one of the broadcasted or multicasted user content version/s when the respective communication device is not capable of handling the respective version/s; transmitting the instructions to the communication devices via broadcasting or multicasting, and transmitting the different versions of user content to the communication devices via broadcasting or multicasting.

The suggested instructions are to be considered as filtering instructions, which can easily be adapted for each respective, associated version of user content, so that only user content which is compatible with a certain communication device will be used by the communication device. Thereby both processing time and power consumption can be reduced.

According to different embodiments, the suggested instruction can be arranged as an element of a service announcement, which is any of a file schedule element or a session schedule element. Alternatively, the instruction can be arranged as an element or attribute of a File Delivery Table (FDT).

According to one embodiment, an element or attribute is set to a free text string representative of certain device capabilities, while according to another embodiment the element or attribute is instead set to at least one key word representative of certain device capabilities.

According to another aspect, a corresponding method to be executed in a communication device for handling broadcasted or multicasted user content received from a network node is suggested. The method comprise: receiving, from the network node, via broadcasting or multicasting, instructions associated with a plurality of different versions of user content; identifying, in the instructions, instructions instructing the communication device to, based on its device capabilities, automatically select at least one of received, broadcasted or multicasted user content version/s when the respective communication device is capable of handling the respective version/s and/or to automatically discriminate at least one received, broadcasted or multicasted user content version/s when the respective communication device is not capable of handling the respective version/s, and determining, for each received user content version, based on the mentioned instructions, whether to select or discriminate the user content version.

By applying the suggested method in a communication device, such a device will be able to automatically distinguish applicable user content from non-applicable user content, without having to involve the user in such a selection.

According to one embodiment, which allow the communication device to save power, the identifying of a user content version to be discriminated by the communication device results in that the communication device is estimating a file delivery period of the identified user content version, and of instructing parts of the communication device to go to sleep for a specified time period in case the estimated file delivery period exceeds a specified threshold value.

More specifically, by estimating a time period during which an undesired version of user content will be delivered, the communication device can turn off certain parts, such as e.g. reception related parts, of the communication device and go to sleep.

In case the estimated file delivery period is considered to be below the specified threshold value, it is typically determined that no part of the communication device is to go to sleep. According to one embodiment, a relevant part or parts of the communication device is/are instructed to process the user content version to be discriminated before the user content version is discarded, i.e. conventional initial processing of received content is followed by discarding the content, thereby avoiding processing, to at least some extent.

According to yet another embodiment, which can be executed either alone or in combination with any other alternative step, an application of the communication device capable of selecting received version is invoked only upon identifying a version which the communication device is capable of handling. In the latter case the relevant application need not be activated at all in case no relevant version is received and identified by the communication device.

According to yet another aspect, a computer program comprising instructions which, when executed on at least one processor, causes the at least one processor to carry out a method according to any of the embodiments mentioned above, is suggested.

According to yet another aspect, a carrier for containing the computer program mentioned above, is suggested, wherein the carrier is one of an electronic signal, optical signal, radio signal, or computer readable storage medium.

According to another aspect an apparatus capable of broadcasting or multicasting user content delivery to communication devices, comprising a processor and a memory, is suggested, where the memory comprise instructions executable by the processor whereby the apparatus is operative to: prepare different versions of user content to be broadcasted or multicasted to the communication devices; prepare, for each version, a respective instruction arranged to instruct each of the communication devices to, based on its device capabilities, automatically select at least one of the broadcasted or multicasted user content version/s when the respective communication device is capable of handling the respective version/s and/or to automatically discriminate at least one of the broadcasted user content version/s when the respective communication device is not capable of handling the respective version/s; transmit the instructions to the communication devices via broadcasting or multicasting, and transmit the different versions of user content to the communication devices via broadcasting or multicasting.

According to one embodiment the apparatus is configured to arrange each instruction as an element of a service announcement when preparing instructions. The apparatus is configured to arrange such an element as any of a file schedule element or a session schedule element.

Alternatively, the apparatus is operative to arrange each instruction as an element or an attribute of a File Delivery Table (FDT).

According to one embodiment, the apparatus is operative to set the element or attribute to a free text string representative of certain device capabilities, while according to another embodiment it is instead configured to set the element or attribute to at least one key word representative of certain device capabilities.

The suggested apparatus, may form part of a Broadcast/Multicast Service Center (BM-SC), or any other network node, which comprises corresponding functionality.

According to another aspect, a communication device capable of handling broadcasted or multicasted user content received from a network node, comprising an apparatus, such as e.g. the one mentioned above is suggested. The suggested communication device comprise a processor and a memory, where the memory comprise instructions executable by the processor whereby the communication device is operative to: receive, from the network node via broadcasting or multicasting, instructions associated with a plurality of different versions of user content; identify, in the instructions, instructions instructing the communication device to, based on its device capabilities, automatically select at least one received, broadcasted or multicasted user content version/s when the respective communication device is capable of handling the respective version/s and/or to automatically discriminate at least one received, broadcasted or multicasted user content version/s when the respective communication device is not capable of handling the respective version/s, and determine, for each received user content version, based on said instructions, whether to select or discriminate the user content version.

According to one embodiment, the communication device is operative to identify the instruction in an element of a service announcement, where such the element may be arranged in any of a file schedule element or a session schedule element.

According to another embodiment, the communication device is operative to identify the instruction in an element or an attribute of a File Delivery Table (FDT).

According to a further embodiment, executable, upon identifying a user content version to be discriminated by the communication device, the communication device is operative to: estimate a file delivery period of said user content version, and instruct at least a part of the communication device to go to sleep for a specified timeperiod in case the estimated file delivery period exceeds a specified threshold value.

The communication device may be configured such that it is operative to instruct part of the communication device to process the user content version to be discriminated after which it is operative to discard the user content version, in case the estimated file delivery period is estimated to be below the specified threshold value.

According to one embodiment, at least one of identifying, estimating and instructing mentioned above is executed by middleware of the communication device.

According to one embodiment, when identifying the instruction, the communication device is operative to identify the instruction as a free text string representative of certain device capabilities of an element or attribute, while, according to another embodiment, the communication device is operative to identify the instruction as at least one key word representative of certain device capabilities of an element or attribute.

According to one embodiment, when identifying the instruction, the communication device is operative to invoke an application capable of selecting a received user content version only upon identifying a version which the communication device is capable of handling. Such an invoking may, according to one embodiment be executed by middleware of the communication device.

### BRIEF DESCRIPTION OF DRAWINGS

Embodiments will now be described in more detail in relation to the accompanying drawings, in which:

FIG. 1 is a simplified system overview of an MBMS or eMBMS enabled communication network.

FIG. 2 is a flow chart illustrating a method, executable at a network node, for distribution of different selectable versions of user content to communication devices.

FIG. 3 is another flow chart illustrating a method, executed at a communication device, for selecting and/or discriminating different versions of user content, according to one embodiment.

FIG. 4 is yet another flow chart illustrating a method, executed at a communication device, for selecting and/or discriminating different versions of user content, according to another embodiment.

FIG. 5 is a block scheme of an apparatus capable of forming part of a communication network according to one embodiment.

FIG. 6 is a block scheme of an apparatus capable of forming part of a communication network according to another embodiment.

FIG. 7 is a block scheme of a communication device according to one embodiment.

FIG. 8 is a block scheme of a communication device according to another embodiment.

### DETAILED DESCRIPTION

Briefly described, methods and arrangements configured to allow a communication device to efficiently select or discriminate different versions of broadcasted or multicasted user content are suggested and described in further detail below.

In the present context communication device is to be construed as any type of device which is capable of communicating with a communication network which is capable of distributing user content via broadcasting or multicasting. More specifically, communication device as used herein may include wireless, handheld mobile communication devices, such as e.g. mobile telephones, Laptops or PADs, stationary communication devices, such as e.g. TV devices, PCs or computers, or unmanned devices, such as e.g. mobile or stationary M2M devices. The M2M devices may e.g. include, but are not limited to digital signage billboards, connected cars, emergence alarm devices or public safety devices.

User content is in the present context to be referred to as any type of content which can be distributed to, and consumed by, a communication device, including content, such as e.g. software updates, advertisements, public safety information, in-vehicle entertainment system updates and movies, which can be broadcasted or multicasted to a communication device.

More specifically, a method to be executed in a network node is disclosed for preparing and transmitting an instruction to a communication device capable of handling broadcasted or multicasted content, where the instruction instructs the communication device on how to respond to received, broadcasted or multicasted user content, wherein the instruction is based on device capabilities, i.e. the device capabilities of the communication device will determine how it will respond to, and handle, broadcasted user content received by the communication device.

Even though the given examples refer to MBMS or eMBMS, it is to be understood that the described concept can be applicable to any type of arrangement which is capable of enabling distinguishing of different broadcasted or multicasted versions based on capabilities of a respective communication device, as described herein. Even though the examples given in this document are only mentioning broadcast scenarios, it is to be understood that the suggested examples and ways of implementations may be applied to multicast scenarios as well, i.e. to the distinguishing of different multicasted versions based on capabilities of a respective communication device.

A corresponding method, to be executed in a communication device, for receiving and handling an instruction, such as the one mentioned above, and associated user content, is also suggested herein, as will be described in more detail below.

In addition, an arrangement for preparing and transmitting instructions and associated user content, as suggested above, as well as a communication device for receiving and handling such instructions and associated user content, are also suggested, as will be described in more detail below.

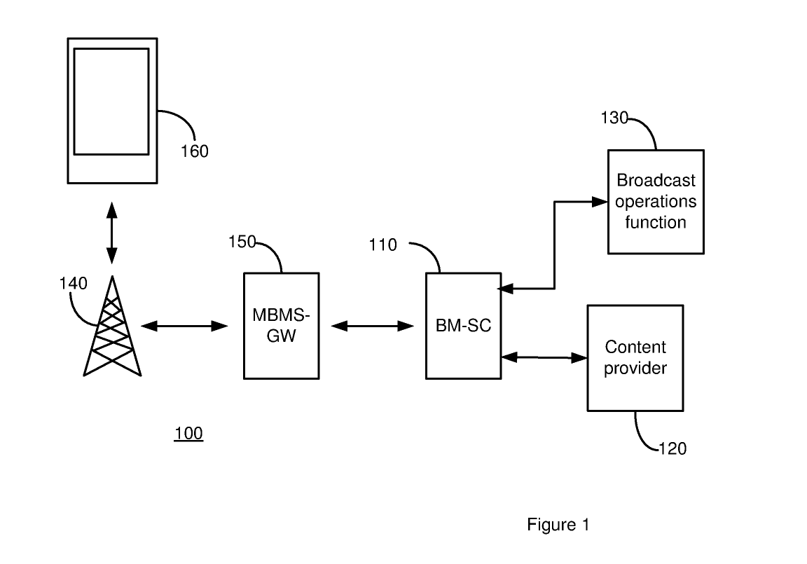

One example of an eMBMS over LTE solution architecture, but which could be applicable also for other communication system capable of distributing content via broadcast or multicast is illustrated in FIG. 1.

It is to be understood that, for simplicity reasons, nodes or entities normally included in the described type of systems but which are not necessary for the understanding of the described solution, have been omitted in FIG. 1. This goes also for the remaining figures where system and/or node architecture is exemplified.

The architecture 100 of FIG. 1 comprises at least one, but typically a plurality of geographically distributed Broadcast Multicast Service Centers (BM-SC) 110, each of which is capable of distributing content provided from one or more content service providers 120, where a content service provider 120 typically comprise a content store (not shown) and a live encoder (not shown) capable of providing content feeds e.g. in the form of satellite feeds, live feeds and/or Content Delivery Network (CDN) feeds, to the BM-SC 110 under supervision of a Broadcast operations function 130, both of which are capable of interacting with the BM-SC 110. The BM-SC 110 is connected to an access network, typically comprising a plurality of geographically distributed access nodes, but for simplicity here represented by one single access node, here represented by eNB 140, via a Multimedia Broadcast Multicast Services Gateway (MBMS-GW) 150, where the eNB 140 is capable of distributing the provided content feeds to communication devices, located within range of the access network, via unicast, multicast or broadcast. While typically a plurality of communication devices at a time are connected to the access network only one single communication device 160 is shown in FIG. 1 for simplicity reasons.

By providing an arrangement in the network which enables the network 100 to provide instructions to the communication devices 160, thereby enabling the communication device 160 to distinguish compatible versions from non-compatible versions, by applying a filtering mechanism as described herein, the communication device 160 will be able to adapt certain functionality accordingly so that a minimum of processing capacity is used for non-compatible versions, while compatible versions are received and processed in a conventional manner.

According to 3GPP TS 26.346, v 12.1.0, section 5.2.2, a service class attribute is defined in the User Service Description (USD) fragment and in the Schedule Description fragment. By using the service class, an application of a communication device will be able to register towards the middleware of the communication device to express its interest in one or more specific services. By taking advantage of such an option, the application need only to receive those services whose service class match its interests, thereby providing for a typical service filtering mechanism on the communication device. From the applications perspective the mentioned service class attribute thereby enables the communication device to differentiate different groups of service, such that e.g. several Disney services share the same service class, as exemplified with the attribute below.

<userServiceDescription serviceId=″urn:ericsson:disney:tvchannel″
serviceClass=″urn:oma:bcast:oma_ext:disney:1.0″>

In the example given above, for the communication devices which are not interested in the services labelled with service class urn:oma_ext:Disney:1.0, an application run on such a communication devices will not register towards the middleware platform for this service class, and, consequently, these services will not be delivered towards the respective application.

According to another alternative for filtering user content, a fileSchedule element of a Schedule fragment typically includes a file URI attribute. By making use of the file name available within the file URI, an application will be able to inform the end users about a respective file, and also to enable the end users to actively choose the files they are willing to receive. Based on the decisions made by the end users, the respective application will be able to inform middleware of the communication device to receive the selected files. An example of such a file schedule information is given below.

```
<fileSchedule>
  <fileURI>http://www.example.com/exampleapp.apk<fileURI>
  <deliveryInfo start=2013-03-01T23:10:00Z end=2013-03-01T23:20:
00Z/>
</fileSchedule>
```

In order to be able to use a fileURI based mechanism, such as the one suggested above, an application will have to ask an end user whether or not a service, here “exampleapp.apk”, which is to be broadcasted via LTE broadcast, is to be received, and the end user have to actively respond to such a request in order to get access to the respective service.

By using the same service class, an operator, a service provider, or a content provider, may offer different user content to different communication devices, and they may also be able to target some user content for specific communication devices.

There are, however, a number of scenarios for which use of service class is not an efficient solution.

According to one scenario, an operator or application provider is planning to distribute OS upgrades for a specific type of communication devices, such as e.g. Android 4 compatible devices. That is, only Android 4 compatible communication devices are expected to receive and perform an upgrade based on such a version, while incompatible communication devices, such as e.g. Android 3 and iPhone devices, are not targeted for the mentioned version.

According to another scenario, different versions, such as e.g. one version configured for iOS terminals and one version for Android devices, of the same software, e.g. a game, is to be distributed for selective implementation at the different communication devices.

According to yet another scenario, an operator or content provider wants to distribute a version of Swedish user content, targeting Swedish capable communication devices. However, any roaming communication device, not supporting Swedish should not be addressed by such a version.

According to a final scenario, corresponding user content is distributed to different communication devices via different TV channels, e.g. two different Disney channels, one using MPEG DASH which is targeted for Android devices, while another one is using HLS which is targeted for IOS devices, due to different encoding mechanisms applied by the different communication devices.

It is to be understood that, throughout this document, version is to be construed as user content associated with a certain service which is suitable for a certain group of communication devices, where each of the communication devices belonging to the same group, have at least one device capability in common.

For none of the use cases mentioned above, it is suitable to rely on that the end user makes a decision on whether or not to receive the respective version, since in all mentioned scenarios, selection of a specific version should be based on device capabilities of a respective communication device, rather than on user preferences of the user of the respective communication device. In other words, in all of the above scenarios, questioning of the user, whether a version should be considered or not would not be the most user friendly approach, since for example Android phone users should not have to be bothered to reply whether or not they are interested to receive and process an iPhone version, of which they have no interest or use. Therefore the fileShedule, mentioned above, is not suitable for filtering also versions comprising device capability dependent user content.

In addition to the scenarios mentioned above, also user specific advertising may be desired from an advertisement provider's point of view. An operator may e.g. want to deliver advertisements towards a number of end users, using a selective advertisement insertion functionality, in order to let the end users watch the advertisements at half time of a football game, where the advertisement provider is willing to distribute different advertisement clips towards different communication devices based on capabilities of respective user group. For the latest use case, advertisement clips can be delivered within the same channel, and there will not be any fileSchedule element available to describe the different advertising clips. Thus, also for such a use case, use of service Class or file URI for distinguishing different advertisements from each other is not suitable.

Consequently, there is known system support for allowing communication devices to separate services based on service classes, where a service class is associated to each broadcast session instance. However, each service class will be valid for an entire broadcast session instance duration, as defined by a session schedule. For many applications, the service class is very course grained, and, thus, forces use of many different service classes. A full set of service announcement fragments therefore need to be generated for each delivery session instance, leading to an increased bitrate need for service announcements and an additional processing load on the communication devices in order to allow for filtering on a per service class base.

The problems mentioned above can be met by applying a method which enables communication devices to filter user content broadcasted towards a respective communication device, which is not targeted for the communication device, based on device capabilities of the respective communication device, thereby efficiently filtering relevant user content from irrelevant user content, without needing to involve users in such a decision.

By introducing such a content filtering scheme, the management overhead as seen from the system side may be considerably decreased. In addition, the number of service announcement fragments that need to be sent with the new, suggested content filtering scheme as described herein may also be decreased considerably.

More specifically, it is suggested that a new content filtering scheme is introduced, where information is applied, which allow content providers to efficiently sub-group each session entry of a file entry.

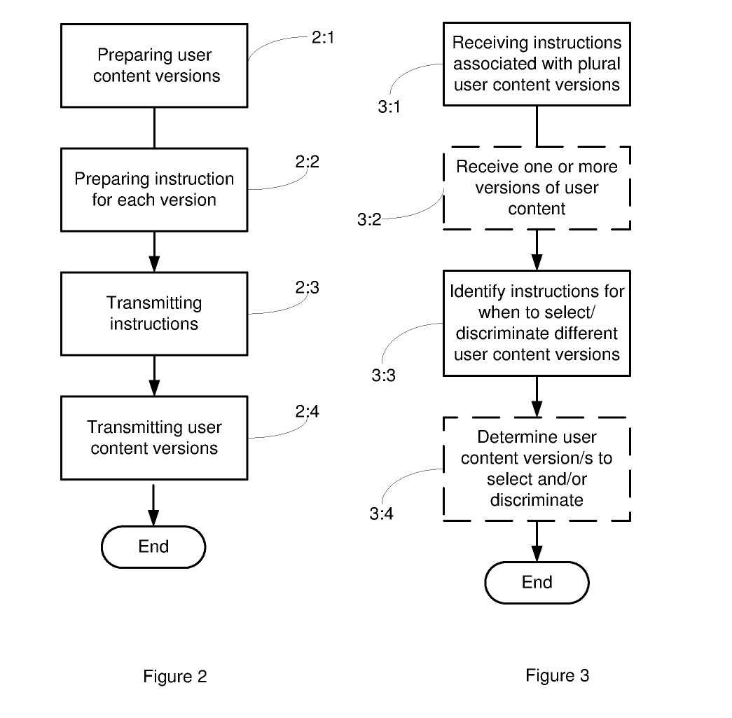

A method, to be executed at a network node, such as e.g. a BM-SC, or any other type of network node, capable of providing corresponding functionality, will now be described in further detail with reference to FIG. 2.

In a first step 2:1 of FIG. 2 a number of different versions are prepared for transmission via broadcasting. Preparation of versions to be distributed also requires preparation of instructions, applicable for each prepared version. This may also be referred to as adapting a service announcement, or a File Delivery Table (FDT), so that it contains information which can later, after reception of such a service announcement or FDT by a communication device, be used for filtering out suitable versions. A preparation of such instructions is indicated in a next step 2:2. In another step 2:3 the instructions are transmitted, via broadcasting, as indicated in a step 2:3, while the different user content versions to which the instructions refer are transmitted, also via broadcasting, in another step 2:4.

Each time there is an update of certain software or any other type of user content, a suitable number of different new versions can therefore easily be prepared and sent, together with associated instructions, as indicated in the method described above.

In another figure, FIG. 3, a corresponding method, executed in a communication device, is suggested. In a first step 3:1, a communication device is receiving instructions, transmitted in a service announcement, an FDT, or any other corresponding format, via broadcasting, after which one or more versions of specific user content, described in the instructions, are received in a next step 3:2. As indicated in another step 3:3, the communication device then identifies instructions, indicating to the communication device, when, or under which conditions, one or more different versions should be discriminated, or filtered, by the communication device, and, thus, which version/s should be considered by the communication device, and in a final step 3:4, the communication device applies the relevant instructions, so that a required, or compatible version is received, selected and processed accordingly by an application of the communication device, while a non-wanted, or incompatible version is not selected at the communication device. It is here to be understood that even though step 3:3 is executed after step 3:2 in FIG. 3, step 3:3 may alternatively be executed, or execution may start, before execution if step 3:2. It is also to be understood that situations may occur where one or both of steps 3:2 and 3:4 fail to occur, i.e. wanted and/or unwanted versions of user content may for one reason or the other not be received and identified by a communication device. Even in such situations, a communication device may gain from having received and interpreted the instructions accordingly, since various subsequent steps may be adapted, e.g. skipped, for different purposes, such as e.g. one or more of: power saving, reduced storage requirements and reduced processing requirements.

Each time new instructions are received and processed accordingly, the method as described above, may be initiated and executed.

According to one embodiment, which can be referred to e.g. as a file filtering mechanism, the filter condition referred to as instructions above, is inserted into a fileSchedule element of a service announcement. Below is an exemplary piece of fileSchedule information provided in a Schedule fragment. The given fileSchedule example, describe how one iOS version (OSVendor includes Apple) and an Android version (OSVendor includes Google) may be described and distinguishable in a file schedule element of a service announcement.

```
<fileSchedule>
  <fileURI filter=”OSVendor includes ‘Apple’”>
    http://www.example.com/exampleapp_ios.apk
  </fileURI>
  <deliveryInfo start=2013-03-01T23: 10:00Z end=2013-03-01T23:20:
00Z/>
</fileSchedule>
<fileSchedule>
  <fileURI filter=”OSVendor includes ‘Google’”>
    http://www.example.com/exampleapp_andriod.pkg
  </fileURI>
  <deliveryInfo start=2013-03-01T23:20:00Z end=2013-03-01T23:30:
00Z/>
</fileSchedule>
```

As indicated in the example given above, the iOS version will be delivered from 2013-03-01 at 23:10:00 until 2013-03-01 at 23:20:00, while the Android version will instead be delivered from 2013-03-01 at 23:20:00 until 2013-03-01 at 23:30:00, i.e. transmission of two different versions are announced to be executed one after another, and, thus, by being aware of this and that one of the versions is of interest to the communication device while the other is not, parts of the communication device may adapt accordingly, e.g. be inactivating certain functionality and thereby reduce battery consumption when a not wanted version is to be distributed, while the corresponding functionality is instead activated when a version of interest to the communication device is to be distributed.

In the present example, the user content filtering is based on the key words “OSVendor” and “includes”, followed by an indication of the relevant version, where “includes” is to be interpreted indicating that the indicated transmission is including the indicated version. Alternatively other key words, such as e.g. “excludes”, indicating that a version does not comprise a certain version, may be used, as long as the receiving communication devices are able to interpret the used terms is intended.

The key words to be used as suggested above may preferably be attributes defined in User Agent Profile (UAProf) specification, e.g., ScreenSizeChar, HtmlVersion, CcppAccept-Language, Model, OSName, OSVersion, etc. Since UAProf is a well-established specification, created by the—Open Mobile Alliance, and compatible with the Composite Capability/Preference Profiles in World Wide Web Consortium, the attributes defined in User Agent Profile are widely understood by both the network nodes and the communication devices. Alternatively, the key words can be based on any other vocabulary which can be understood by involved entities.

When applying key words, software, hardware and/or middleware of a communication device may, depending on relevant configuration, be configured to recognize and interpret the respective key word/s and, since the respective functionality is configured to know which version to use and/or which version not to use, it will be able to interpret the one or more key words accordingly.

By applying file filtering, where filtering conditions are indicated in the file URI element, as suggested above, a communication device will be able to check its stored OSVendor information and determine whether or not its capabilities are compatible with a respective version. In the present scenario this may e.g. mean that for an iOS communication device, the corresponding Android version can be skipped, while the Android communication devices instead can choose to ignore the iOS version. Different versions may also be distinguished based on other criteria, such as e.g. screen resolution. The screens of most Android and iPhone phones are e.g. smaller than the screens of iPad and Android tablets.

Alternatively, instead of using certain key words the new content filter element may be provided as a free text string, so that the definition of the actual filter is completely up to the content provider, operator or other responsible for introducing the suggested filtering. In case a free text string is used, middleware of the communication devices may e.g. be configured to pass an identified filter text string to an application, which is capable of processing the text string on its own. For example, a social network application on the device may keep track of some user information including birthday information, and the social network service provider may deliver a special birthday greeting clip with a simple filter text “to birthday men/women”. The application can understand and process such a filter, and, based on the filter information it will be able to present a birthday greeting to those birthday men/women which are fulfilling that criteria, while such a clip will be discriminated for other users.

The used filter may alternatively, depending on the respective version category, apply to other communication device capabilities, such as e.g. language, which enables an operator, content provider or other provider to use one and the same bearer for delivery of multiple versions of certain user content, and a communication device to automatically select appropriate version, depending on present device capabilities.

The example given below exemplifies how a filter may apply to language capabilities. In the given file Schedule example, a French version and a corresponding English version of a certain movie are provided. Here the French version will be delivered from 2013-03-01 at 23:20:00 until 2013-03-01 at 23:30:00, while the English version is going to be delivered from 2013-03-01 at 23:30:00 until 2013-03-01 at 23:40:00.

```
<fileSchedule>
  <fileURI filter=”lang=‘FR’”>
  http://www.example.com/examplemovie_fr.mov
  </fileURI>
  <deliveryInfo start=2013-03-01T23:20:00Z end=2013-03-01T23:30:
00Z/>
</fileSchedule>
<fileSchedule>
  <fileURI filter=”lang=‘EN’”>
  http://www.example.com/examplemovie_en.mov
  </fileURI>
  <deliveryInfo start=2013-03-01T23:30:00Z end=2013-03-01T23:40:
00Z/>
</fileSchedule>
```

Alternatively, a content provider will be able to distribute a Swedish version of certain user content, which is targeted for Swedish capable communication devices, while roaming communication devices which do not support Swedish will be able to ignore such versions.

When applying file filtering, middleware of a communication device may be adapted such that the schedule fragment is checked, and, based on the capabilities of the communication device, the middleware determines whether filtering should be done or not, i.e. whether or not to consider a specific file version.

Alternatively, in case the middleware of a communication device is integrated into the OS, the OS platform, rather than the middleware can perform the suggested filtering. According to yet another alternative embodiment, the filtering may be executed, and the decision on which version to process could be taken directly by the application. Corresponding alternative embodiments are also applicable as possible alternatives to all middleware related example given below.

If a respective version is to be filtered, the middleware may be configured not to pass the respective fileSchedule information towards a respective application, presently running on the communication device. In this way, applications will not be made aware of such a version, and, as a consequence, the middleware will not get any instruction from the application to receive this file version, and thus no version will be accepted by mistake. By closing down middleware of the communication device when certain conditions are fulfilled, e.g. after it has been determined that a, for the communication device, irrelevant version is to be transmitted during a certain time interval, the overall power consumption of the communication device may be more efficient. Alternatively, instead of middleware, appropriate hardware may be configured to interact accordingly in order to close down at least a part of the communication device.

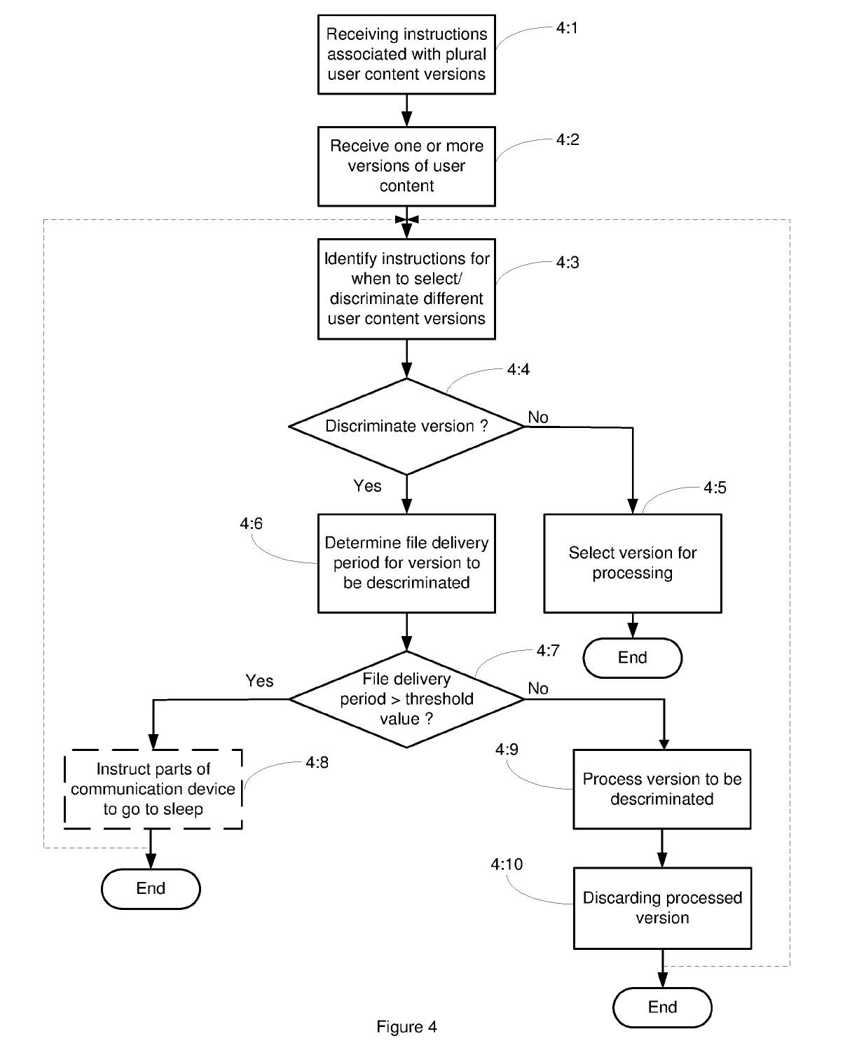

One other example, which may be applicable to any of file filtering, session filtering or FDT filtering, executed at a communication device, is illustrated in FIG. 4, where steps 4:1-4:3 corresponds to steps 3:1-3:3 of FIG. 3, respectively, and will therefore not be described any further here. As indicated in following step 4:4, however, the identification of relevant instructions, is followed by determining, based on identified instructions, whether or not filtering is to be applied, and thus if an identified version is to be discriminated or not. In case no discrimination, or no filtering, is to be made, i.e. if it has been determined in step 4:4 that a version which is relevant for the communication device has been received by the communication device, by comparing filtering criteria provided in received instructions to stored device capabilities, the received version is selected for processing accordingly, as indicated in step 4:5, after which the process is terminated, while in case a received version is instead to be discriminated, the described process continues by determining a relevant file delivery period for the version to be discriminated, as indicated with step 4:6.

In case file filtering or session filtering is applied the determining step is executed by determining the relevant file delivery period from the information acquired in the received instructions, while in case the corresponding information is obtained from an FDT instance, the determining step is achieved by estimating the relevant file delivery period. Such an estimation can be based on the file size as well as the transmission bandwidth. Typically, the estimated period can be the file size divided by the transmission bandwidth. The file size is typically included in the FDT (i.e., Content-Length or Transfer-Length in FDT). While the transmission bandwidth can be obtained from the SDP in the service announcement (i.e., the value of “b=AS” SDP attribute), or obtained from the Modem component of the communication device. For example, if the file size indicated in the Content-Length in FDT is 250000 Bytes (no content encoding applied), and the value of “b=AS” in SDP is 100 kb/s, the transmission period can be estimated to 20 seconds=250000*8/(100*1000).

In a next step 4:7, following step 4:6, it is determined whether or not the estimated file delivery period exceeds a certain threshold value, which may be set e.g. to 5 seconds. If the determined file delivery period is found to exceed the threshold value, one or more parts of the communication device is/are instructed to go to sleep for a certain time interval, as indicated with step 4:8. In step 4:8, the modem of the communication device may e.g. be the part that is set to sleep, and in such a case the relevant application will not be made aware of any upcoming version which is distributed within the threshold value. The suggested option of setting one or more parts of the communication device to sleep is particularly suitable if applied on middleware and/or modem of the device, but corresponding functionality may be applied also for functionality other than middleware, or the modem. As an alternative to set one or more parts to sleep, relevant receiving functionality may be disabled completely for the determined time interval.

If instead, the estimated file delivery period is determined in step 4:7 to be shorter than the determined threshold value, no parts will be set to go to sleep, since in such a situation it is determined that there is not enough to gain on initiating any such power saving process. Instead the version to be discriminated is processed, e.g. stored in a storage area of the communication device, in a conventional manner, as indicated with step 4:9, after which the version is discarded, as indicated in step 4:10. Alternatively, the version may be partially processed, i.e. the conventional processing is only partly executed, before the version is discarded.

It is to be understood that, even though step 4:8 and 4:10 are followed by a termination of the described process in FIG. 4, these steps may alternatively be continued by proceeding again from step 4:3, e.g. in case there is any additional version to consider, which may either be discriminated or selected subsequently. In other words, the suggested steps may be repeated until instructions for all received versions have been considered accordingly.

For DASH/HLS, content is segmented into a plurality of segment files, where FDT filtering needs to be done on a per filter basis. In such a situation, the communication device will get the filter information from the FDT, check one file, make a decision on this file based on the relevant filter information, and repeat this process until the end of the session.

According to another embodiment a filter mechanism to be applied in a service announcement may instead be applied in a sessionSchedule element, where such filtering may be referred to as session filtering. Session filtering is applicable for file delivery, as well as video session delivery. In a scenario where two live channels are going to be delivered, one channel may e.g. be using HLS to perform encoding targeting iOS communication devices, while another channel is instead using MPEG DASH to perform encoding which is targeting Android communication devices.

Not all files will be described by the fileSchedule element in a Schedule fragment. E.g. for a live channel, there will not be any fileSchedule elements available to describe the segment files to be delivered from the network. An operator or any other content provider may e.g. deliver advertisements towards end users, using appropriate, conventional advertisement insertion functionality, so that the end users watching a game on a sports arena will be able to watch these advertisements e.g. at half time of a football game. At such a scenario, different advertisement clips, may be distributed towards different end users, where these different end users may be capable to filter different versions, based on the relevant user group, specified by device capabilities.

According to yet another embodiment, filtering criteria can therefore instead be introduced in an attribute of an FDT instance. To achieve this relevant information need to be cached in the communication device. When receiving the FDT instance, the communication device will be able to check end user related information locally, and decide whether or not to receive a specific version of a file or not. An example of providing filtering criteria in an attribute of an FDT instance is presented below.

```
<FDT-Instance Expires=″3557781711″>
  <File TOI=″10000″ filter=″users are iPhone users″ Content-Location=″
  http://www.example.com/ads_iPhone.m4s ″ Content-Length=″4045744″
  Transfer-Length=″4045744″ Content-Type=″video/mp4″ Content-
  MD5=″H+3wXJKB2mM+EEDWptPUZw==″ FEC-OTI-FEC-Encoding-
ID=″1″
  FEC-OTI-FEC-Instance-ID=″0″ FEC-OTI-Maximum-Source-Block-
  Length=″1024″ FEC-OTI-Encoding-Symbol-Length=″120″ FEC-OTI-
  Scheme-Specific-Info=″ACEBCA==″>
</File>
  <File TOI=″10001″ filter=”users are Android users” Content-
  Location=″http://www.example.com/ads_android.m4s″ Content-
  Length=″43893321″ Transfer-Length=″43893321″ Content-
  Type=″video/mp4″ Content-MD5=″Y+/JbApWVahnbpXZawazuA==
″ FEC-
  OTI-FEC-Encoding-ID=″1″ FEC-OTI-FEC-Instance-ID=″0″ FEC-OTI-
  Maximum-Source-Block-Length=″1024″ FEC-OTI-Encoding-Symbol-
  Length=″120″ FEC-OTI-Scheme-Specific-Info=″AWYBCA==″>
</File>
</FDT-Instance>
```

If instead of an attribute, an element is used in an FDT Instance, such an example may look as follows:

<File TOI=″10000″ Content-Location=″
http://www.example.com/ads_iPhone.m4s ″ Content-Length=″4045744″
Transfer-Length=″4045744″ Content-Type=″video/mp4″ Content-
MD5=″H+3wXJKB2mM+EEDWptPUZw==″ FEC-OTI-FEC-Encoding-
ID=″1″
FEC-OTI-FEC-Instance-ID=″0″ FEC-OTI-Maximum-Source-Block-
Length=″1024″ FEC-OTI-Encoding-Symbol-Length=″120″ FEC-OTI-
Scheme-
Specific-Info=″ACEBCA==″>
<Filter Criteria=″users are iPhone users″/>
</File>

By apply filtering based on content provided in an FDT instance, an operator or a content provider may be able to deliver different advertisements to different communication devices, in the examples given above, by distinguishing between advertisements addressed for iPhone users and Android users.

By applying the suggested method according to any of the embodiments mentioned above for enabling device capabilities based filtering operators and content or application providers will be able to freely distribute different versions of user content on one single bearer, wherein communication devices will be able to automatically select relevant versions, while irrelevant versions can instead be discriminated.

In one scenario, applicable to the FDT instance embodiment mentioned above, middleware may be capable of checking the FDT instance and decide whether or not to filter a certain version. In case filtering is determined, the middleware may request bandwidth information from the modem of the communication device. Based on the information retrieved from the FDT instance, in combination with the bandwidth provided from the modem, the middleware will be able to estimate the file delivery period. As already described above, with reference to FIG. 4, a threshold may be decisive of whether or not the middleware is to instruct the modem to go to sleep for a determined time interval. In case of a small file version which duration does not exceed the threshold value, the modem may receive the file version, but may then discard the received file version in order to save memory space. Alternatively, appropriate hardware may perform the corresponding functionality as is executed by middleware in the example mentioned above.

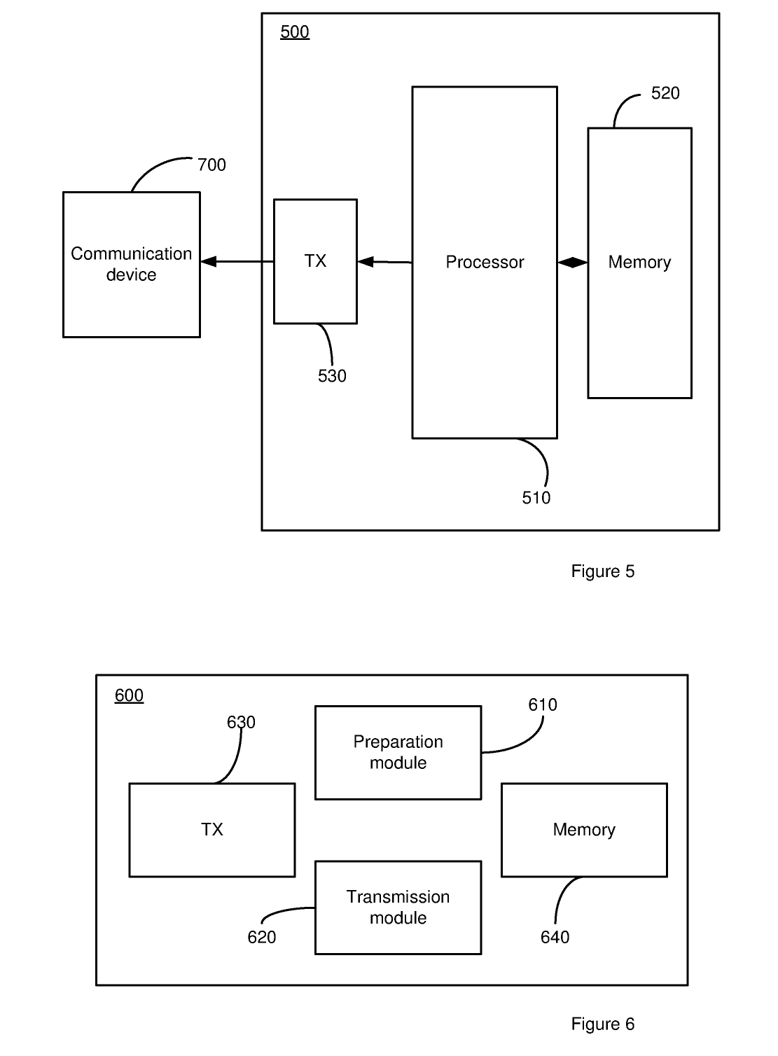

An apparatus, which is forming part of, or is connected to, a BM-SC, or any other network node, having corresponding functionality for distributing broadcasted user content to communication devices via broadcasting, and which is capable of executing any of the network node related methods mentioned above will now be described in further detail below with reference to FIGS. 5 and 6.

The apparatus 500 of FIG. 5 comprises at least one processor, here represented by processor 510, and at least one memory, here represented by memory 520, the memory 520 comprising code executable by the processor 510 whereby the apparatus 500 is operative to prepare different versions of user content to be broadcasted to communication devices 700, to prepare, for each version, a respective instruction arranged to instruct each of the communication devices to, based on its device capabilities, automatically select at least one of the broadcasted user content version/s when the respective communication device is capable of handling the respective version/s and/or to automatically discriminate at least one of the broadcasted user content version/s when the respective communication device is not capable of handling the respective version/s, to transmit the instructions to the communication devices via broadcasting via a transmitter 530, and to transmit the different versions of user content to the communication devices via broadcasting via transmitter 530.

Code may also, when executed, provide instructions comprising at least one element of a service announcement.

When preparing the instructions, executable code of the apparatus may be configured to arrange an element of a service announcement as any of a file schedule element or a session schedule element. More specifically, each instruction may be configurable as an element or attribute of an FDT.

Furthermore, code may, when executed, according to one embodiment be configured to set an element or attribute to a free text string representative of certain device capabilities, while, according to another embodiment, elements and attributes may instead be set to one or more key words representative of certain device capabilities.

The executable code mentioned above may be stored on a non-volatile memory, e.g. a flash memory, a disc drive, a RAM (Random-access memory) ROM (Read-Only Memory) or an EEPROM (Electrically Erasable Programmable Read-Only Memory) as a computer program, wherein that memory 520 may also be referred to as a computer program product (CPP), which may form part of the apparatus 500.

Alternatively, an apparatus 600, capable of executing functionality which corresponds to apparatus 500 may according to another embodiment be configured as described below with reference to FIG. 6, comprising a plurality of interacting modules or units, which may be configures as software modules or units, hardware modules or units, or a combination of both. One or more processors or processing units (not shown) may constitute one or more of the modules and/or control one or more of the modules or units. A preparation module or unit 610 is configured to execute steps, which correspond to steps 2:1 and 2:2 of FIG. 2 and a transmitting module 620 which is configured to execute steps, which correspond to steps 2:3 and 2:4, via a transmitter (TX) 630. The apparatus 600, also comprises a memory 640, which corresponds to the memory 520 of FIG. 5.

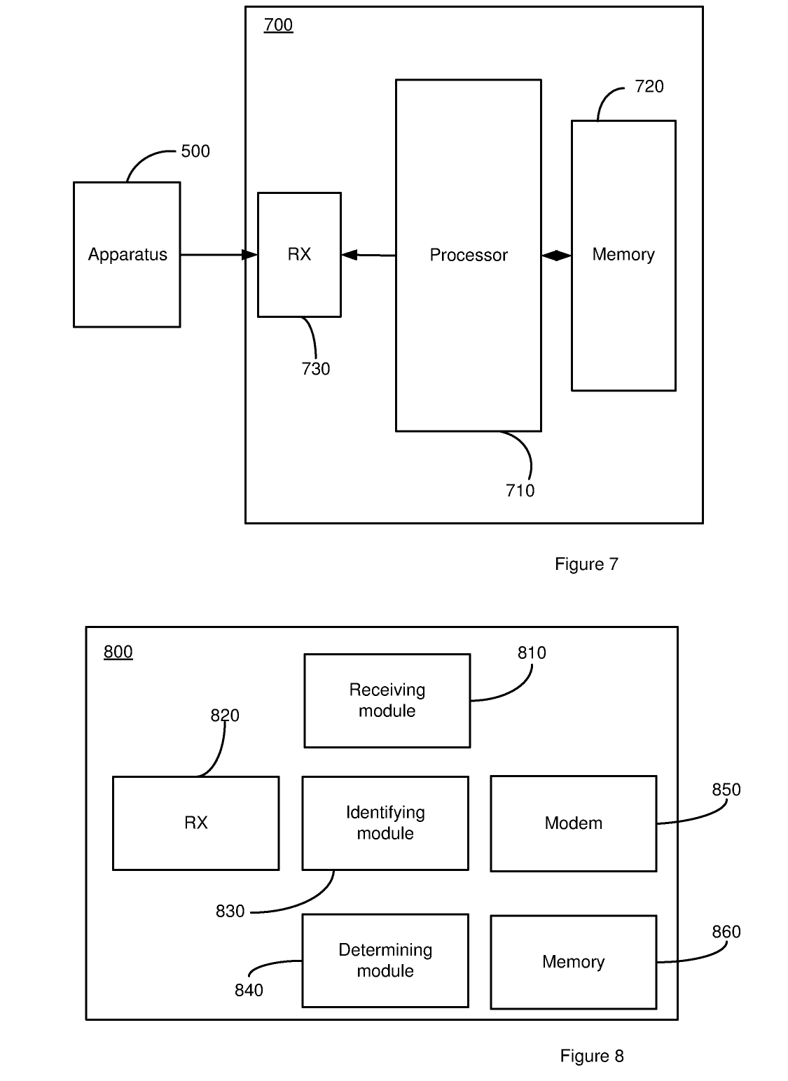

A communication device, capable of receiving and processing the data provided from an apparatus, such as the one described above, with reference to FIG. 4 or 5, will now be described in further detail, with reference to FIGS. 7 and 8.

The communication device 700 of FIG. 7 comprises at least one processor, here represented by processor 710, and at least one memory, here represented by memory 720, the memory 720 comprising code executable by the processor 710 whereby the communication device 700 is operative to receive, from the network node via broadcasting, instructions associated with a plurality of different versions of user content, to receive at least one of the versions of user content as broadcasted user content, to identify, in the instructions, instructions instructing the communication device 700 to, based on its device capabilities, automatically select at least one of the broadcasted user content version/s when the respective communication device 700 is capable of handling the respective version/s and/or to automatically discriminate at least one of the broadcasted user content version/s when the respective communication device 700 is not capable of handling the respective version/s, and to determine, for each received user content version, based on the instructions, whether to select or discriminate the user content version.

Code of the communication device may, when executed, be operative to identify the instruction in an element of a service announcement. More specifically, the communication device may be operative to identify the element of a service announcement in any of a file schedule element or a session schedule element.

When identifying an instruction, the communication device 700 may be operative to identify such an instruction in an element or attribute of an FDT. Furthermore. upon identifying, a user content version to be discriminated by the communication device, the communication device 700 may comprise instructions which when executed causes the communication device 700 to estimate a file delivery period of said user content version, and to instruct parts of the communication device 700 to go to sleep for a specified time period in case the estimated file delivery period exceeds a specified threshold value.

According to one embodiment, code of the communication device 700 may, when executed, cause the communication device 700 to execute the identification and estimation from middleware of the communication device 700. More specifically, following instructing parts of the communication device, the communication device may be operative to instruct part of the communication device to process the user content version to be discriminated after which it is operative to discard the user content version, in case the estimated file delivery period is estimated to be below the specified threshold value. The communication device 700 may in the latter case be operative to instruct part of the communication device, such as e.g. a modem, from middleware of the communication device. Alternatively, hardware of the communication device may execute the functionality executed by middleware in the example given above.

Code may, when executed, according to one embodiment, cause the communication device to identify an instruction as a free text string representative of certain device capabilities of an element or attribute, while, according to another embodiment, the communication device may instead be operative to identify the instruction as at least one key word representative of certain device capabilities of an element or attribute.

The communication device 700 may comprise code, which when executed causes the communication device 700 to, upon identifying an instruction, invoking an application capable of selecting a received user content version only upon identifying a version which the communication device is capable of handling. In the latter case the communication device may be operative to invoke the application from middleware or hardware of the communication device.

The executable code mentioned above may be stored on a non-volatile memory, e.g. a flash memory, a disc drive, a RAM (Random-access memory) ROM (Read-Only Memory) or an EEPROM (Electrically Erasable Programmable Read-Only Memory) as a computer program, wherein that memory 720 may also be referred to as a computer program product (CPP), which may form part of the apparatus 700.

Alternatively, a communication device 800, capable of executing functionality which corresponds to communication device 500 may according to another embodiment be configured as described below with reference to FIG. 8, comprising a plurality of interacting modules or units, which may be configures as software modules or units, hardware modules or units, or a combination of both. One or more processors or processing units (not shown) may constitute one or more of the modules and/or control one or more of the modules or units. A receiving module or unit 810 is configured to execute steps, which correspond to steps 3:1 and 3:2 of FIG. 3 and 4:1 and 4:2 of FIG. 4, via receiver 820, and an identifying module 830 which is configured to execute steps, which correspond to step 3:3 of FIG. 3 and 4:3 of FIG. 4. In addition the communication device 800 comprises a determining unit 840, which is configured to execute a step corresponding to step 3:4 of FIG. 3. Alternatively, the determining module may be configured to execute steps 4:4-4:11 of FIG. 4.

As has already been mentioned above, a communication device may comprise middleware (not shown) which, based on the outcome of a possible filtering, may be configured to control a modem 850, or any other appropriate functionality, such that power consumption is saved. The communication device 800, also comprises a memory 860, which corresponds to the memory 720 of FIG. 7.

It is to be understood that the described communication device may be a more or less advanced device operated by an end user, or a completely automated device which is configured to perform certain tasks which may e.g. include measuring and/or controlling tasks. Therefore the described communication device may typically comprise further functional modules or units, such as e.g. a user interface, a display, as well as sensors.

It is also to be understood that the choice of modules or units, as well as the naming of the units within this disclosure are only for exemplifying purpose. It should also be noted that the modules or units described in this disclosure are to be regarded as logical entities which are not with necessity configured as separate physical entities, but which could alternatively be configured as combined units or modules, as long as the described functionality can be obtained.

Any of the processors mentioned above may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processors may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

The scope of the following claims should not be limited by the preferred embodiments as set forth in the examples given above, but should be given the broadest interpretation consistent with the description as a whole.

1. A method executed in a network node capable of broadcasting or multicasting user content to communication devices, the method comprising:
preparing a plurality of versions of user content to be transmitted to the communication devices via broadcasting or multicasting, said plurality of versions including a first version of the user content and a second version of the user content;
for the first version of the user content, preparing a first instruction comprising first information for enabling a communication device to determine whether the communication device should i) automatically select the first version of the user content or ii) discriminate the first version of the user content;
for the second version of the user content, preparing a second instruction comprising second information for enabling a communication device to determine whether the communication device should i) automatically select the second version of the user content or ii) discriminate the second version of the user content;
transmitting the first and second instructions via broadcasting or multicasting, and
transmitting the plurality of versions of the user content via broadcasting or multicasting.

2. The method according to claim 1, wherein transmitting the first and second instructions comprises transmitting a service announcement, wherein the first and second instructions are included in the service announcement.

3. The method according to claim 2, wherein
the first instruction is included in one of: a first file schedule element of the service announcement and a first session schedule element of the service announcement.

4. The method according to claim 1, wherein transmitting the first and second instructions comprises transmitting a File Delivery Table (FDT), wherein the first and second instructions are included in the FDT.

5. The method according to claim 1, wherein the first instruction is a free text string representative of certain device capabilities.

6. The method according to claim 1, wherein the first instruction comprises a key word representative of certain device capabilities.

7. A method in a communication device for handling broadcasted or multicasted user content received from a network node, the method comprising:
receiving, from the network node via broadcasting or multicasting, a first instruction associated with a first version of user content and a second instruction associated with a second version of the user content;
identifying, in the first instruction, first information for enabling the communication device to, based on its device capabilities, determine whether the communication device should i) automatically select the first version of the user content or ii) discriminate the first version of the user content,
identifying, in the second instruction, second information for enabling the communication device to, based on its device capabilities, determine whether the communication device should i) automatically select the second version of the user content or ii) discriminate the second version of the user content,
determining, for the first version of the user content, based on said instructions, whether to select or discriminate the first version of the user content, and
determining, for the second version of the user content, based on said second instruction, whether to select or discriminate the second version of the user content.

8. The method according to claim 7, wherein receiving the first and second instructions comprises receiving a service announcement, wherein the first and second instructions are included in the service announcement.

9. The method according to claim 8, wherein the first instruction is included in one of: a first file schedule element of the service announcement and a first session schedule element of the service announcement.

10. The method according to claim 7, wherein receiving the first and second instructions comprises receiving a File Delivery Table (FDT), wherein the first and second instructions are included in the FDT.

11. The method according claim 7, wherein,
in response to determining to discriminate the first version of the user content, the communication device: estimates a delivery period of the first version of the user content and determines whether the estimated delivery period exceeds a threshold, and
in response to determining that the estimated delivery period exceeds a threshold, instructs a part of the communication device to go to sleep for a specified time period as a result of determining that the estimated delivery period exceeds the threshold.

12. The method according to claim 7, wherein
in response to determining to discriminate the first version of the user content, the communication device: estimates a delivery period of the first version of the user content and determines whether the estimated delivery period exceeds a threshold, and
discards the first version of the user content after it is received.

13. The method according to claim 7, wherein the first instruction is a free text string representative of certain device capabilities.

14. The method according to claim 7, wherein the first instruction is comprises a key word representative of certain device capabilities.

15. The method according to claim 7, wherein an application of the communication device capable of selecting received version is invoked only upon identifying, a version which the communication device is capable of handling.

16. A computer program product comprising a non-transitory computer readable medium storing a computer program comprising instructions which, when executed on at least one processor, causes the at least one processor to carry out the method according to claim 1.

17. The method of claim 2, wherein
the first instruction is included in a value portion of a filter attribute of a fileURI element of a first file schedule element of the service announcement,
the fileURI element of the first file schedule element includes a pointer to the first version of the user content,
the second instruction is included in a value portion of a filter attribute of a fileURI element of a second file schedule element of the service announcement, and
the fileURI element of the second file schedule element includes a pointer to the second version of the user content.

18. An apparatus capable of broadcasting or multicasting user content to communication devices, comprising:
a processor; and
a memory, the memory comprising instructions executable by the processor wherein the apparatus is operative to:
prepare a plurality of versions of user content to be transmitted to the communication devices via broadcasting or multicasting, said plurality of versions including a first version of the user content and a second version of the user content;
for the first version of the user content, prepare a first instruction comprising first information for enabling a communication device to determine whether the communication device should i) automatically select the first version of the user content or ii) discriminate the first version of the user content;
for the second version of the user content, prepare a second instruction comprising second information for enabling a communication device to determine whether the communication device should i) automatically select the second version of the user content or ii) discriminate the second version of the user content;
transmit the first and second instructions via broadcasting or multicasting, and
transmit the plurality of versions of the user content via broadcasting or multicasting.

19. The apparatus according to claim 18, wherein the apparatus transmits the first and second instructions by transmitting a service announcement, wherein the first and second instructions are included in the service announcement.

20. The apparatus according to claim 19, wherein the first instruction is included in one of: a first file schedule element of the service announcement and a first session schedule element of the service announcement.

21. The apparatus according to claim 18, wherein the apparatus transmits the first and second instructions by transmitting a File Delivery Table (FDT), wherein the first and second instructions are included in the FDT.

22. The apparatus according to claim 18, wherein the first instruction is a free text string representative of certain device capabilities.

23. The apparatus according to claim 18, wherein the first instruction comprises a key word representative of certain device capabilities.

24. The apparatus according to claim 18, wherein the apparatus is part of a Broadcast/Multicast Service Center (BM-SC).

25. A communication device for handling broadcasted or multicasted user content received from a network node, comprising:
a processor; and
a memory, the memory comprising instructions executable by the processor wherein the communication device is operative to:
receive, from the network node via broadcasting or multicasting, a first instruction associated with a first version of user content and a second instruction associated with a second version of the user content;
identify, in the first instruction, first information for enabling the communication device to, based on its device capabilities, determine whether the communication device should i) automatically select the first version of the user content or ii) discriminate the first version of the user content,
identify, in the second instruction, second information for enabling the communication device to, based on its device capabilities, determine whether the communication device should i) automatically select the second version of the user content or ii) discriminate the second version of the user content,
determine, for the first version of the user content, based on said instructions, whether to select or discriminate the first version of the user content, and
determine, for the second version of the user content, based on said second instruction, whether to select or discriminate the second version of the user content.

26. The communication device according to claim 25, wherein the communication device is operable to receive the first and second instructions by receiving a service announcement, wherein the first and second instructions are included in the service announcement.

27. The communication device according to claim 26, wherein the first instruction is included in one of: a first file schedule element of the service announcement and a first session schedule element of the service announcement.

28. The communication device according to claim 25, wherein the communication device is operable to receive the first and second instructions by receiving a File Delivery Table (FDT), wherein the first and second instructions are included in the FDT.

29. The communication device according to claim 25, wherein
the communication device is configured such that, in response to determining to discriminate the first version of the user content, the communication device: estimates a delivery period of the first version of the user content and determines whether the estimated delivery period exceeds a threshold, and
the communication device is further configured such that, in response to determining that the estimated delivery period exceeds a threshold, the communication device instructs a part of the communication device to go to sleep for a specified time period.

30. The communication device of claim 25, wherein
the communication device is configured such that, in response to determining to discriminate the first version of the user content, the communication device: estimates a delivery period of the first version of the user content and determines whether the estimated delivery period exceeds a threshold, and
the communication device is further configured such, as a result of determining that the estimated delivery period does not exceed the threshold, that the communication device receives the first version of the user content and then discards the received first version of the user content.

31. The communication device according to claim 25, wherein the communication device is operative to execute at least one of identifying, estimating and instructing from middleware of the communication device.

32. The communication device according to claim 25 wherein, when identifying the instruction, the communication device is operative to identify the instruction as a free text string representative of certain device capabilities of an element or attribute.

33. The communication device according to claim 25 wherein, when identifying the instruction, the communication device is operative to identify the instruction as at least one key word representative of certain device capabilities of an element or attribute.

34. The communication device according to claim 25 wherein when identifying the instruction, the communication device is operative to invoke an application capable of selecting a received user content version only upon identifying a version which the communication device is capable of handling.

35. The communication device of claim 34, wherein the communication device is operative to invoke the application from middleware of the communication device.
